(19) United States
(12) Patent Application Publication
(10) Pub. No.: US 2006/0114771 A1
(43) Pub. Date: Jun. 1, 2006

(54) Method and system for adjusting the servo control by monitoring the spot status on photo detector of optical pickup head

(75) Inventor: Sheng-Fa Hou, Hsin-Chu City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/184,785

(22) Filed: Jul. 20, 2005

(30) Foreign Application Priority Data
Nov. 30, 2004 (TW) 093136837

(51) Int. Cl. G11B 7/00

(52) U.S. Cl. 369/44.23; 369/112.01

(57) ABSTRACT

The invention discloses a system and method for adjusting the servo controls by monitoring the spot status projected upon the photo detector of an optical pickup head. By utilizing a beam splitting device, the present invention splits the reflected laser beam which projects to photo detector originally into two reflected laser beams, in which a first reflected laser beam still projects to the photo detector for generating the servo control signals, and a second reflected laser beam projects to an image sensor for obtaining the beam profile of reflected laser beam as the servo control still works normally. By reference to analyze the obtained beam profile, the characteristics of the optical pickup head system would be more realized and be helpful for adjusting the optical servo control system.

### BACKGROUND OF THE INVENTION

1. Field of the Invention

The invention relates to a servo control system of an optical disc drive. More particularly, the invention relates to a method and a system for adjusting the servo control by monitoring the spot status on the photo detector.

2. Description of the Prior Art

An ordinary optical disc drive reads out the data stored on a disc by detecting the reflected laser beam via a pickup head. FIG. 1 is a structure diagram of the pickup head of a conventional optical disc drive. Light source 100, for example a laser diode, emits a laser beam with a fixed wavelength accurately onto a recording layer 140 of an optical disc by propagating through a polarized beam splitter (PBS) 110, a relay lens set 120, and an objective lens 130. The reflected laser beam from the optical disc is guided to form a spot properly on a photo detector 160 by propagating through the objective lens 130, the relay lens set 120, the polarized beam splitter (PBS) 110, and a focusing lens 150. The photo detector 160 detects the spot projected on the detecting plane of the photo detector 160 and transforms the optical signals into electronic signals via a photoelectric conversion for generating servo control signals, thereby controlling the operations of the pickup head. Besides, the above-mentioned electronic signals are also transmitted to a signal processor (not shown in the drawing) for further extraction of the stored data.

The operations of the pickup head is mainly controlled by a servo control system of an optical disc drive. The servo control system is capable of controlling objective lens 130 by a focusing actuator to make the laser beam properly focus on the optical disc 140 (focusing servo), and moving the pickup head parallel to the disc plane by a sled motor and a tracking actuator to make the laser spot exactly project on the center of a track (Track-Following servo).

Referring to FIG. 2A-2E, the common photo detector has a detecting plane that is divided into four quadrants: A, B, C, and D. Each quadrant detects the intensity of light projected on it and further generates electronic signals respectively. By reference to a signal processor, the combinations of the four electronic signals generated by the four quadrants are processed to regenerate the stored data on the disc. Besides, by comparing the spot status on the detecting plane, the status of focusing and the track-following can be determined, and the servo control system can further controls the pickup head. As shown in FIG. 2A, the spot 200 illustrates the spot on the photo detector 160 with accurate focusing and track-following. If a spot 210 on the photo detector 160 is in the shape of an ellipse with a B-D alignment (as shown in FIG. 2B), it means the objective lens 130 in FIG. 1 is too close to the optical disc; on contrast, if a spot 220 is in the shape of an ellipse with an A-C alignment (as shown in FIG. 2C), it means the objective lens 130 is too far from the optical disc. The two cases mentioned above show that the pickup head does not have a proper focusing on the disc. As for the spot 230 shown in FIG. 2D, it means the pickup head deviates and does not exactly follow the track.

Since the reflected laser beam provides both the information for servo control and the information of the stored data, improper track-following and focusing can directly influence the accuracy of the servo control and data extraction. Conventional photo detectors can only detect the spot intensity by dividing the detecting plane into four quadrant regions, and it is unlikely to have the detail beam profile of the reflected laser beam by conventional photo detector. However, sometimes the detail beam profile of the reflected laser beam could contain very critical information for servo control. Referring to FIG. 2E, the spot 240 shapes the same to the spot 200 which is with exact focusing and track-following. But the distribution of light intensity of spot 240 is not as uniform as spot 200. The uneven distribution of light intensity may be due to aberration from inclination of discs, inclination of objective lens 130, or inclination of other lens sets and thus for example results in the higher intensity in the A and B quadrants. The conventional four-quadrant photo detector can not differentiate the spot 240 with the spot 230, therefore it could not find the aberration phenomenon or the inclined optical disc. In this case, if the photo detector could perform a more accurate detection about the reflected laser beam, it might help the servo control system to have a better control against the aberration or the inclination of lens and discs. An instinctive solution is to utilize an image sensor having a higher image resolution instead of the four-quadrant photo detector. However, the bandwidth requirement for reading the stored data on the optical disc is about tens of MHz while most image sensors, such as a 80×80 pixels charged coupled device (CCD) sensor or a CMOS sensor, are not practicable because their transmission bandwidth is too low (usually about tens of kHz).

Accordingly, the current pickup head could not simultaneously provide the sufficient information to servo control system and detect the detailed beam profile of the reflected laser beam. Even adopting the image sensors with high image resolution instead of the conventional four-quadrant photo detector, the bandwidth thereof does not satisfy the demand for high-speed transmission of an optical disc drive. Hence, the invention provides a new system for adjusting the servo control of an optical disc drive, which allows the pickup head to detect the beam profile of the reflected laser beam while performing normal servo controls.

### SUMMARY OF THE INVENTION

As mentioned above, an objective of the invention is to provide an optical drive, which might detect the detailed beam profiles of the reflected laser beam as well as the servo control system, which operates normally. By analyzing the beam profile of a reflected laser beam, the characteristics of the pickup head and the servo control thereof might be further realized, thereby being helpful to the optical drive design.

Besides, detecting the beam profile of the reflected laser beam could obtain a distinct pickup head status, for example the disc is inclined, thereby assisting the servo controls of an optical drive. Another objective of the invention is to provide a fine tunable optical drive that can fine-tune the servo controls of an optical drive or further provide other servo controls optionally.

According to the objectives of the invention, a beam-splitting device is disposed on the optical path of the reflected laser for obtaining two reflected laser beams within a similar beam profile. One reflected laser beam projects to a four-quadrant photo detector for generating servo control signals and further being processed to extract the stored data on the disc. Another reflected laser beam projects to an image sensor for obtaining an identical beam profile with the beam profile of the reflected laser beam projected on four-quadrant photo detectors. In the next procedure, a beam profile analyzer analyzes the beam profile to finely tune the focusing control and the track-following control, or further provides additional servo controls, such as the tilt control, to the optical drive. Saying a beam-splitting device could simply be a beam splitter, a cubic beam splitter, or other practicable optical lens, and saying image sensor has higher image sensitivity, such as an 80×80 pixel CCD/CMOS camera. Besides, in the embodiments of the invention, a set of lenses disposed between the said beam-splitting device and the said image sensor may be applied to acquire a more distinct beam profile.

### BRIEF DESCRIPTION OF THE DRAWINGS

Other objects, features, and advantages of the invention will become apparent from the following detailed description of the preferred embodiments with reference to the accompanying drawings in which:

FIG. 1 is a structure diagram of the pickup head of a a convention optical disc drive;

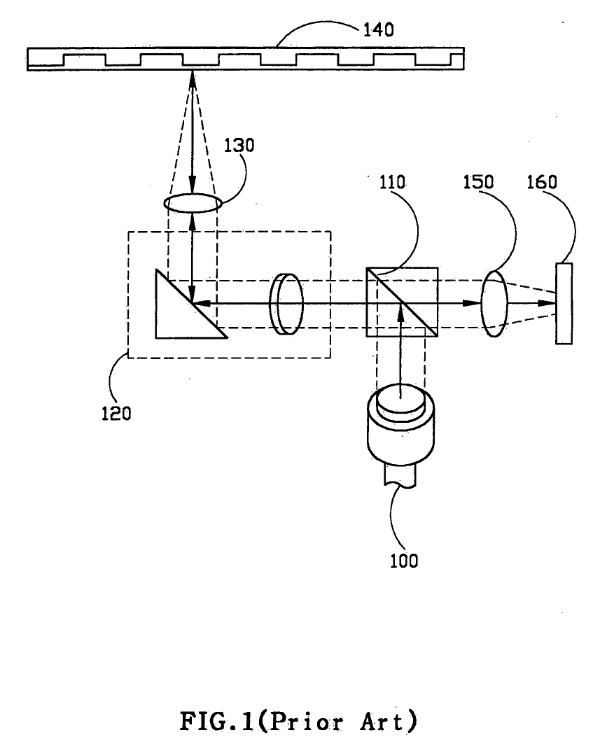

FIG. 2A to FIG. 2E illustrates different spot status on the photo detector;

FIG. 3A is a block diagram illustrating a first embodiment of the system for adjusting the servo control according to the present invention;

FIG. 3B is a block diagram illustrating a second embodiment of the system for adjusting the servo control according to the present invention;

FIG. 4 illustrates an embodiment of the monitoring system according to the present invention; and

FIG. 5 is a flow chart illustrating a method for adjusting the servo control according to the present invention.

### DETAILED DESCRIPTION OF THE INVENTION

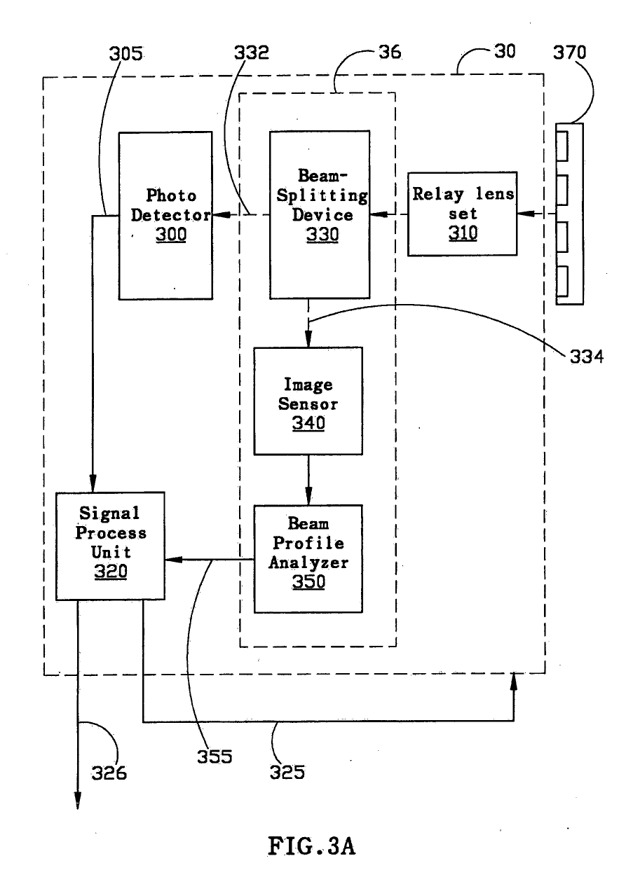

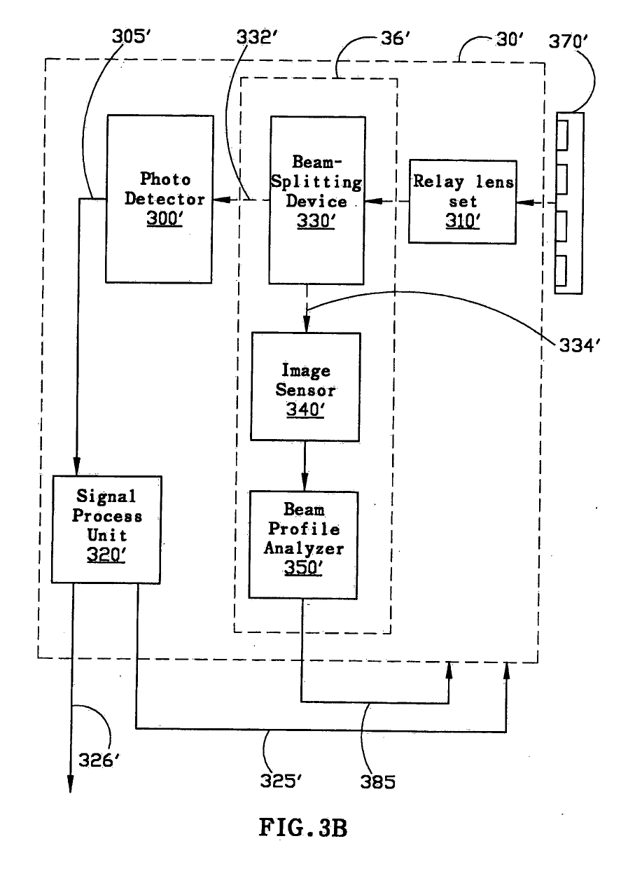

FIG. 3A is a block diagram illustrating a first embodiment of the system for adjusting the servo control according to the present invention. For simplifying the drawing, FIG. 3A depicts only the optical path of the reflected laser beam without further explaining the emitting of the laser beam. In FIG. 3A, solid arrows are used to show the electric signal path while the dotted arrows are used for optical paths. Basically, the conventional optical disc drive includes a photo detector 300, a relay lens set 310, and a signal processing unit 320. Photo detector 300 contains a detecting plane divided into four quadrants A, B, C, and D for receiving the reflected laser beam from disc 370, and transforming it into electronic signals 305 for the signal process unit 320. The signal process unit 320 processes the electronic signals 305 to generate servo control signals 325, which are further transmitted to a focusing actuator, sled motor, and tracking actuator (not shown in the drawing) for managing the track-following and the focusing operations of a pickup head. Besides, the signal processing unit 305 further transforms the electronic signals 305 into digital data signals 326 for succeeding decoding circuits, thereby reading out the stored data on the optical disc 370. The relay lens set 310 represents the optical components disposed in the optical path from the optical disc 370 to the photo detector 300 such as various kinds of lens, reflect mirror, collimating lens, etc. The main purpose of relay lens set 310 is to make the reflected laser beam properly projecting on the photo detector 300.

With comparisons to a conventional optical drive, the optical disc drive 30 according to the first embodiment of the present invention further has a monitoring system 36 that contains a beam-splitting device 330, an image sensor 340, and a beam profile analyzer 350. The beam-splitting device 330 splits the reflected laser beam into two reflected laser beams having the same beam profiles, in which a first reflected laser beam 332 still projects onto the photo detector 300 for generating the servo control signals and information for stored data, and a second reflected laser beam 334 projects onto an image sensor 340. The same beam profiles means the spot on the photo detector 300 and the image sensor 340 are supposed to have similar intensity distribution and shapes though the total energy for each spot is not necessary equal to one another. The beam-splitting device 330 could be a beam splitter, a cubic beam splitter, or a polarized beam splitter which transmits part of incident light intensity to a photo detector 300 and reflects part of incident light intensity to the image sensor 340. The transmission/reflection ratio of a beam-splitting device 300 could be tuned according to the coating on the beam splitting device 330, and the intensity of the split two reflected laser beams 332, 334 is not necessary equal to one another.

Image sensor 340 detects the spot imaging upon the detecting plane thereof for converting the second reflected laser beam 334 into electronic signals, wherein the electronic signals will later output to the beam profile analyzer 350. The image sensor 340 has a higher image resolution than a conventional photo detector 300, for instance an 80×80 pixel CCD or CMOS sensor. A beam profile analyzer 350 analyzes the beam profiles of the second reflected laser beam 334 to adjust the servo control of an optical drive. In other words, the beam profile analyzer 350 processes the input electronic signals from the image sensor 320 to output a control signal 355 to a signal process unit 320 for adjusting the servo control signal 325.

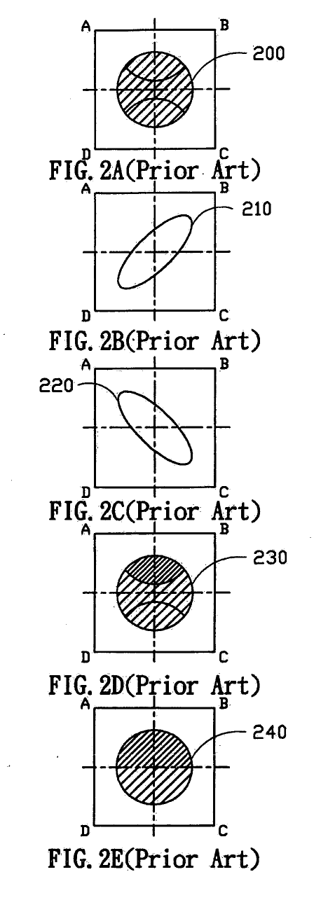

For example, referring to FIG. 2E, the spot 240 has larger light intensity over AB quadrants. As mentioned before, the spot 240 may be caused by an inclined disc or inclined objective lens, which is unrecognizable with a spot 230 (FIG. 2D) by a conventional four-quadrant photo detector. Assuming that the track-following control of an optical drive is determined according to the function of (A+B)−k(C+D), wherein k is fixed coefficient 1 in conventional optical drive, and A, B, C, and D represent the generated electronic signal of each detecting quadrant. In accordance with saying function, signal process unit 320 generates the track-following control signal to control the pickup head moving inner/outer of the disc.

The combination of image sensor 340 and beam profile analyzer 350 detects the effects resulting from a inclined disc; further the beam profile analyzer 350 generates a control signal 355 to signal process unit 320 for adjusting the servo control 325. The said control signal 355 may modify the coefficient k (i.e., change coefficient k from 1 to 1.3) to compensate for the tilt condition, or adjust the weighting of A, B, C, and D signals while combining them as digital data signal 326 for extracting data more accurately.

FIG. 3B is a block diagram illustrating a second embodiment of the system for adjusting the servo control according to the present invention. In this embodiment, the control signal is generated by beam profile analyzer for tuning the optical drive directly without being processed by the signal processing unit 320′. Contrary to the first embodiment, beam profile analyzer 350′ analyzes the beam profiles of a reflected laser beam 334′, and generates another servo control signal 385 by reference to another signal process unit that is built-in in the beam profile analyzer 350′ (not shown in the drawing). The said control signal 385 tunes the servo control of the optical drive, for instance, by controlling the rotating speed of an optical disc or the tilt angle of an objective lens. The output signal 305′ of the photo detector 300′ is still passed to the signal process unit 320′ (similar to the signal process unit 320 of FIG. 3A) for generating digital data signal 326′ and servo control signal 325. Functions of other components, such as photo detector 300′, beam-splitting device 330′, or image sensor 340′ . . . etc., are the same to those in FIG. 3A, which will not be described redundantly.

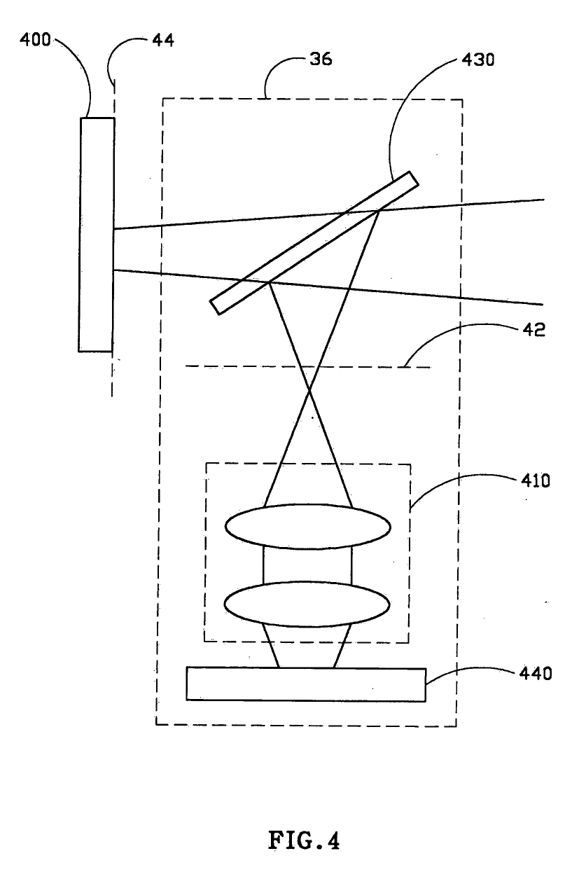

Beside, some optical lenses may be added to the optical path from a beam-splitting device 330 to the image sensor 340 to make the image projected upon image sensor 340 being clearer. FIG. 4 illustrates an embodiment of the monitoring system 36 according to the present invention. After being split by the beam-splitting device 430, the reflected laser beam forms a spot imaged at the plane 42 has the same beam profile to that upon plane 44 on the pphoto detector 400. The image sensor 440 could be moved from the original position of the plane 42 to the position as 440 shows, and a set of lens 410 which contains a convex lens, objective lens, or other optical lens, is added between the plane 42 and image sensor 440 to enlarge the spot imaging upon the detecting plane of image sensor 440, thereby having the beam profile with enhanced details.

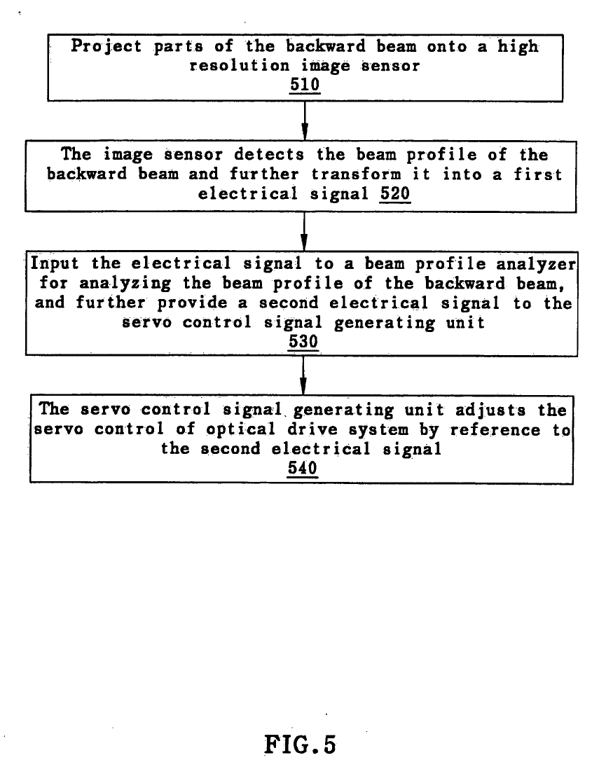

FIG. 5 is a flow chart illustrating a method for adjusting the servo control according to the present invention. The method comprises the steps of: first, project parts of the reflected laser beam onto a high-resolution image sensor (step 510). Then the said image sensor detects the beam profile of the reflected laser beam and further transforms it into a first electronic signal (step 520). Next, input the first electronic signal to a beam profile analyzer for analyzing the beam profile of the reflected laser beam, and further provides a second electronic signal to the servo control signal generating unit (step 530). Afterwards, the servo control signal generating unit adjusts the servo control of an optical drive by reference to the second electronic signal (step 540).

The said servo control signal generating unit is the signal process unit 320, 320′ appeared in FIG. 3A, 3B, or might be integrated into the beam profile analyzer 350′. In addition, the ways for adjusting the servo control, for instance by modifying the gains of each quadrant detecting plane to adjust the servo control signal, are not limited to that described in the preferred embodiment of the invention.

Hence, it concludes that the optical drive, which utilizes an image sensor having a higher resolution to obtain the beam profiles of a reflected laser beam benefits from achieving better servo control performance. Furthermore, the present invention doesn't discard the original servo control mechanism of the optical drive, but merely increases a beam-splitting device and an image sensor to obtain the detailed beam profile of the reflected laser beam. Therefore, it helps to improve the servo control performance of an optical drive without surging the costs of manufacturing.

The above-mentioned are only the preferred embodiments of the present invention, not intended to limit the scope thereof. It will be appreciated and carried out by those professions skilled in the art. Thus, many modifications of the embodiments that can be made without departing from the spirit of the present invention should be covered by the following claims.

What is claimed is:

1. An optical drive adjusts the servo controls by monitoring the spot status on a photo detector of an optical pickup head, said optical drive comprising:
a set of relay lens, said set of relay lens transmits an optical signal reflected from a disc;
a photo detector, said photo detector receives parts of said optical signal to generate a first electronic signal via photoelectric conversion;
a signal process unit electrically coupling with said photo detector, which receives said first electronic signal to generate a servo control signal; and
a monitoring system, which receives parts of said optical signal and outputs a second electronic signal to said signal process unit for adjusting said servo control signal.

2. The optical drive of claim 1, wherein said monitoring system further comprising:
a beam-splitting device, which splits said optical signal into a first optical signal and a second optical signal, wherein said first optical signal further projects on said photo detector;
an image sensor, which detects beam profiles of said second optical signal to generate a third electronic signal via the photoelectric conversion; and
a beam profile analyzer electrically coupling with said image sensor and said signal process unit, said beam profile analyzer analyzes said third electronic signal for generating said second electronic signal to said signal process unit.

3. The optical drive of claim 2, wherein said beam-splitting device disposes between said set of relay lens and said photo detector.

4. The optical drive of claim 2, wherein said beam-splitting device is a beam splitter

5. The optical drive of claim 2, wherein said beam-splitting device is a cubic beam splitter.

6. The optical drive of claim 2, wherein said image sensor is a CCD sensor.

7. The optical drive of claim 2, wherein said image sensor is a CMOS sensor.

8. The optical drive of claim 2 further comprising a set of lens disposing between said beam-splitting device and said image sensor for enlarging an imaging upon said image sensor.

9. The optical drive of claim 1, wherein a detecting plane of said photo detector divides into four quadrant, said signal process unit adjusts said servo control signal by modifying gains for each quadrant of said detecting plane.

10. A method for adjusting the servo control by monitoring the spot status on a photo detector of the optical pickup head, said method comprising:
splitting a reflected laser beam reflecting from a disc into a first reflected laser beam and a second reflected laser beam;
projecting said second reflected laser beam to an image sensor for detecting a beam profile of said second reflected laser beam;
analyzing said beam profile of said second backward for providing a control signal; and
adjusting a servo control signal in accordance with said control signal;
wherein a four-quadrant photo detector detects said first reflected laser beam for generating said servo control signal.

11. The method of claim 10 further comprising a servo control signal generating unit electrically coupling with said photo detector and said beam profile analyzer for receiving a electronic signal of said photo detector to generate said servo control signal.

12. The method of claim 10, wherein said image sensor is a CCD camera.

13. The method of claim 10, wherein said image sensor is a CMOS sensor.

14. An optical drive provides an additional servo control by monitoring the spot status on a photo detector of the optical pickup, said optical drive comprising:
a set of relay lens, which is used to transmit an optical signal reflected from a disc;
a beam-splitting device for splitting said optical signal into a first optical signal and a second optical signal;
a photo detector for detecting said first optical signal to generate a first electronic signal;
a signal process unit electrically coupling to said photo detector, said signal process unit generates a first servo control signal in accordance with said first electronic signal;
an image sensor, which detects beam profiles of said second optical signal to generate a second electronic signal; and
a beam profile analyzer electrically coupling with said image sensor for generating a second servo control signal in accordance with said second electronic signal;
wherein the optical drive performs servo controls by reference to said first servo control signal and said second servo control.

15. The optical drive of claim 14, wherein said beam-splitting device is a beam splitter.

16. The optical drive of claim 14, wherein said beam-splitting device is a cubic beam splitter.

17. The optical drive of claim 14, wherein said image sensor is a CCD sensor.

18. The optical drive of claim 14, wherein said image sensor is a CMOS sensor.
